(19) United States
(12) Patent Application Publication
(10) Pub. No.: US 2009/0308889 A1
(43) Pub. Date: Dec. 17, 2009

(54) CONTAINER SYSTEM

(76) Inventors: Frank Lindsay, Hamilton Square, NJ (US); Dean M. Mohamed, Clifton, NJ (US)

Correspondence Address: CHURCH & DWIGHT CO., INC., LAW DEPT. - PATENTS, 469 NORTH HARRISON STREET, PRINCETON, NJ, 08543-5297, US

(21) Appl. No.: 12/137,284

(22) Filed: Jun. 11, 2008

(51) Int. Cl. B67D 5/56

(52) U.S. Cl. 222/129; 222/135

(57) ABSTRACT

A container system includes a concentrate component having at least one concentrate container, each including a vessel defining a cavity, and a neck portion extending from the vessel, an opening extending through the neck portion and in fluid communication with the cavity, a concentrate stored in the cavity, and a seal which is operatively associated with the opening for sealing the concentrate within the cavity. The container system further includes a main component having a main container including an opening and a cavity in fluid communication with the opening, a coupling means located at the opening of the main container for receiving and fluidly coupling with the neck portion of the concentrate container, and a discharge mechanism operatively associated with the coupling means, wherein the discharge mechanism is adapted for operatively engaging the sealing means to initiate the release of the concentrate from the concentrate container into the cavity of the main container.

### FIELD OF THE INVENTION

The present invention relates to containers for storing and dispensing fluid products (e.g., liquid products), and more particularly to a container system including at least two containers in the form of a large container for preparing the fluid product, and at least one smaller container each adapted for operating contact with the larger container for storing and dispensing a concentrate into the larger container.

### BACKGROUND OF THE INVENTION

Numerous forms of containers have been designed for dispensing liquids for different uses. Such uses may include cleaning applications, pesticide applications, soap dispensing applications, cosmetic applications, chemical specialties, and the like. One popular form of dispensing container is the spray bottle container that can squirt, spray or mist fluids. Such spray bottle containers comprise a bottle (holding a liquid or spray product to be dispensed), a trigger-spray mounted on the mouth of the bottle, and a dip tube extending from the trigger-spray into a lower region of the bottle. On actuating the trigger, the contents of the bottle are discharged as a spray through the nozzle of the trigger-spray bottle. Depending on the sprayer, the nozzle may or may not be adjustable, so as to select between squirting a stream, aerosolizing a mist, or dispensing a spray.

Manufacturers typically market spray products by utilizing plastic bottles and spray heads. The manufacturers fill the bottles with the spray product, assemble and label the completed spray bottle container packages for delivery to retailers for sale to consumers. The consumers purchase the filled spray bottle containers at the point of sale, and then use the spray product contents of the spray bottle container.

The sale of such pre-filled containers is costly in terms of energy consumption and environmental impact. A typical spray product used in standard spray bottle containers is composed mostly of liquid diluents (e.g., water), which adds substantial weight to the overall spray bottle container package. Considerable cost and energy usage is incurred during the handling, transport and storage of the pre-filled containers from manufacturer to retailer, and also from retailer to consumer. Moreover, this practice encourages one-time use and disposal of the still-functional spray bottle containers, when all of the spray product has been dispensed. As a result, large numbers of potentially reusable products (i.e., empty spray bottle containers) are discarded into landfills.

Some manufacturers have attempted to sell concentrates of spray products in various sized containers to allow consumers to refill or recharge point-of-sale-type spray bottle containers. However, many consumers have not been willing to adopt such refill methods apparently due to inconveniences associated with the refill steps involved. Some may be reluctant to mix or dilute liquids due to inexperience or lack of knowledge. The refilling process can be messy due to overfilling, spilling the concentrate while pouring the concentrate from one container to the other, accidentally knocking over the bottle, or other difficulties associated with refilling containers.

Some concentrates may be hazardous to transport and handle by consumers who may be unaware of the potent chemical properties. Specifically, spillage of concentrates may damage items around the home including flooring, carpeting, counter tops in kitchens and bathrooms, shelves, and other home items the concentrate may potentially come into contact with. Further, concentrates may pose potential health risks to the consumer coming into accidental contact therewith causing tissue burns or other injuries. Concentrates may also pose a great risk to children who may accidentally ingest the concentrate. Concentrates can potentially inflict permanent injury or death to children because of the high concentration of the active ingredients as compaired to the fully diluted formulation contained in point-of-sale type spray bottle containers.

Accordingly, there is a need for a container system that is designed to alleviate the problems described above, while remaining cost effective and simple to make and use. There is a need for a container system that is consistent with environmentally friendly practices, while providing substantial cost and energy savings during shipping. There is a further need for a container system that delivers a ready-to-use product to a container in a safe, easy and economical manner, while utilizing existing bottle designs with minimal modifications to yield a simple overall construction and assembly. There is a further need for a container system that can be reused.

### SUMMARY OF THE INVENTION

The present invention relates to a container system including at least two containers in the form of a large container for preparing the fluid product, and at least one smaller container each adapted for operating contact with the larger container for storing and dispensing a concentrate into the larger container. In particular, the container system of the present invention utilizes a main container, which may be in the form of a spray bottle container of conventional interior design, and at least one smaller concentrate container each retaining a quantity of a concentrate for subsequent dilution in the main container with a consumer supplied diluent (e.g. water) to produce a ready to use fluid product. The container system of the present invention can be implemented for transport or storage in a dry state (i.e. diluent absent) to yield substantial cost and energy savings and promote environmentally friendly practice and conservation.

In addition, the container system can further be reused via refilling of the main container through the use of a concentrate supplied from a concentrate container. The container system of the present invention is designed to deliver a ready-to-use product to a container in a safe, easy and economical manner, while utilizing existing container designs with minimal modifications to yield a simple overall construction and assembly.

Although the present invention will be described in the context of a spray bottle container, it will understood that the present invention will not be limited to such embodiments. In fact, the present invention can readily be extended or modified for use with any containers adapted for storing and dispensing a wide range of fluids including liquids or other flowable materials such as powders, slurries and particulates. The present invention has a reusable feature in that the main container can be refilled with additional concentrate after the initial fluid product has been at least substantially dispensed there from, Which is facilitated by the operable contact of the container exterior to the main container.

There is provided a container system, which comprises a main container including an opening, and a cavity in fluid communication with the opening, wherein the opening of the main container is adapted to receive and fluidly couple through a coupling mechanism with a concentrate container which essentially lies exterior to the main container. The concentrate container retains a quantity of a concentrate through an initially sealed opening. A discharge mechanism located proximate to the opening of the main container, and is adapted for operative engagement with the sealed opening of the concentrate container to break the seal and thereby initiate the release of the concentrate from the concentrate container into the cavity of the main container. The discharge mechanism of the main container not only unseals the concentrate container to thereby release the concentrate, but does so in a manner that prevents against accidental discharge of the concentrate outside of the main container.

In one aspect of the present invention, there is provided a container system, comprising:
(a) a concentrate component comprising:
   at least one concentrate container, each including a vessel defining a cavity, and a neck portion extending from the vessel;
   an opening extending through the neck portion and in fluid communication with the cavity;
   a concentrate stored in the cavity; and
   sealing means operatively associated with the opening for sealing the concentrate within the cavity; and
(b) a main component comprising:
   a main container including an opening and a cavity in fluid communication with the opening;
   coupling means located at the opening of the main container for receiving and fluidly coupling with the neck portion of the concentrate container; and
   a discharge mechanism operatively associated with the coupling means, the discharge mechanism being adapted for operatively engaging the sealing means to initiate the release of the concentrate from the concentrate container into the cavity of the main container.

In another aspect of the present invention, there is provided a container system, comprising:

at least one concentrate container, each including an opening and a cavity in fluid communication with the opening thereof, the cavity of the concentrate container being adapted to retain a quantity of a concentrate;

sealing means operatively associated with the opening of the concentrate container for sealing the concentrate within the cavity;

a main container including an opening, and a cavity in fluid communication with the opening thereof, the opening of the main container being adapted to receive and fluidly couple with the opening of the concentrate container; and

a discharge mechanism located proximate to the opening of the main container, the discharge mechanism being adapted for operative engagement with the sealing means of the concentrate container to initiate the release of the concentrate from the cavity of the concentrate container into the cavity of the main container.

In a further aspect of the invention, the coupling means is provided with one or more structural features that facilitate transfer of the concentrate contained within the concentrate container to the main container without accidental spillage of the concentrate outside of the respective containers.

### BRIEF DESCRIPTION OF THE DRAWINGS

The following drawings are illustrative of embodiments of the present invention and are not intended to limit the invention as encompassed by the claims forming part of the application.

FIG. 1 is a partial cross-sectional view from the side of a container system for one embodiment of the present invention, showing a main container in the form of a spray bottle and a concentrate container;

FIG. 2 is a cross-sectional assembly view of the container system shown with a trigger-spray removed from a spray bottle in accordance with the present invention;

FIG. 3 is an exploded cross-sectional view of the coupled portions of the main container and the concentrate container as the concentrate is released into the main container in accordance with the present invention.

FIG. 4 is a perspective view of the embodiment of a coupling element for positioning in the neck portion of the main container;

FIG. 5 is a bottom perspective view of the coupling element shown in FIG. 4; and

FIG. 6 is a top perspective of the coupling element shown in FIG. 4.

### DESCRIPTION OF THE INVENTION

The present invention is directed to a container system including at least two containers: one in the form of a relatively large container (hereafter “the main container”) for preparing and dispensing the fluid product; and at least one relatively smaller container (hereinafter the “concentrate container”), each adapted for operating contact with the main container for storing and dispensing a concentrate into the larger container to prepare the fluid product. In particular, the container system of the present invention utilizes a main container, which may be in the form of a bottle of conventional interior design, and at least one concentrate container each retaining a quantity of a concentrate for subsequent dilution in the main container to produce a ready to use fluid product. The container system of the present invention can be implemented for transport or storage in a dry state (i.e., diluent absent) to yield substantial cost and energy savings and promote environmentally friendly practice and conservation.

In addition, the container system can be reused by refilling the main container through the use of a concentrate supplied from a concentrate container. The container system of the present invention is flexible and inexpensive to produce and transport and offers a variety of concentrates from which the consumer can select the desired concentrate for a particular application or need.

The container system of the present invention is specifically designed to provide enhanced handling with minimal complications, while avoiding or at least substantially minimizing spillage of the concentrate during the process of loading the concentrate into the main container. The container system of the present invention is designed to deliver a ready-to-use product to a container in a safe, easy and economical manner, while utilizing existing container designs with minimal modifications to yield a simple overall construction and assembly. To minimize spillage, the concentrate container operatively engages the main container while exterior to the main container. In Addition, the main container is provided with a collar in the neck portion thereof, which facilitates operative contact of the concentrate container and the release of the concentrate into the main container while minimizing spillage.

There is provided a container system, which comprises a main container including an opening, and a cavity in fluid communication with the opening, wherein the opening of the main container is adapted to receive and fluidly couple with a concentrate container through a discharge mechanism. Each concentrate container retains a quantity of a concentrate through an initially sealed opening. The discharge mechanism in the form of a coupling element (hereinafter described) is located proximate to the opening of the main container, wherein the discharge mechanism is adapted for operative engagement with the sealed opening of the concentrate container to initiate the release of the concentrate from the concentrate container into the cavity of the main container without accidental spillage.

Although the present invention will be described in the context of a main container in the form of a spray bottle, it is understood that the present invention is not limited to such embodiments. The present invention can readily be extended or modified for use with any containers adapted for storing and dispensing a wide range of fluids including liquids or other flowable materials such as powders, slurries and particulates. The present invention has a reusable feature in that the main container can be refilled with additional concentrate after the initial fluid product has been at least substantially dispensed.

The term “concentrate” refers generally to a substance, composition or formulation that has not been diluted with a carrier or diluent such as a liquid (e.g., water) to thereby form a final dilute concentration. Typically, but not always, the concentrate will be in the dry state. The concentrate may be formed directly or may be formed from a dilute formulation wheren the diluent has at least been substantially removed. The resulting concentrate provides a substantial reduction in weight and volume for transportation and storage where the concentrate can subsequently be re-constituted into a ready to use fluid product by the consumer at the time of usage. The concentrate may be in the form of any fluids including liquids and flowable materials such as powders, slurries, particulates, and the like.

The term “diluent” refers generally to a substance or composition (in the case of a liquid, the solvent), which may be inert or active (e.g., as forming part of a multi-component solution), and which are locally available for the consumer's use to dilute the active ingredient(s) in the concentrate down to a desired diluted concentration range. The most common diluent is water.

In one embodiment of the present invention, there is provided a container system including at least one concentrate container, each including a vessel defining a cavity, and a neck portion extending from the vessel, an opening extending through the neck portion and in fluid communication with the cavity, a concentrate stored in the cavity, and sealing means operatively associated with the opening for sealing the concentrate within the cavity prior to operative engagement with the main container. The container system further includes having a main container including an opening and a cavity in fluid communication with the opening. There is also provided a coupling means, which may be in the form of a coupling element hereinafter described, located at the opening of the main container for receiving and fluidly coupling with the neck portion of the concentrate container, and a discharge mechanism operatively associated with the coupling means. The discharge mechanism is adapted for operatively engaging the sealing means to initiate the release of the concentrate from the concentrate container into the cavity of the main container. The coupling means includes structural features that prevent accidental spillage of the concentrate during release of the concentrate into the main container.

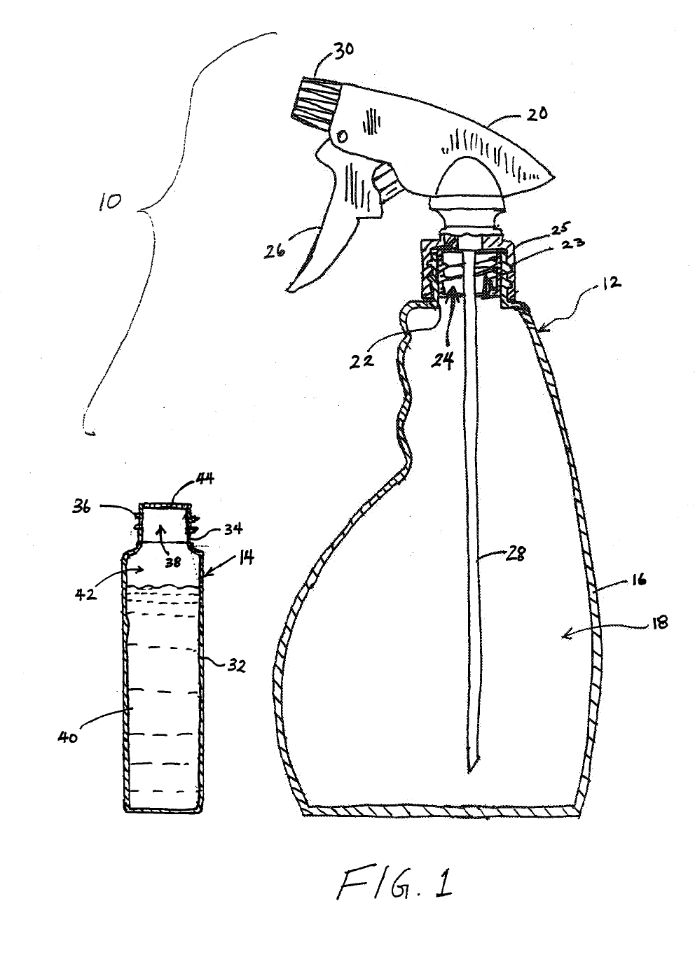

Referring to FIG. 1, a container system, identified generally by reference numeral 10, is shown for one embodiment of the present invention. The system 10 comprises a main container 12 shown in the form of a spray bottle container, and a relatively smaller concentrate container 14. It will be understood that the main container is not limited to a spray bottle container, and is illustrated as such for the purpose of describing the present invention. The main container 12 and the concentrate container 14 are preferably composed of a glass, metal, or plastic material (e.g., polyethylene, high density polyethylene, polypropylene, polyvinyl chloride, polyethylene terephthalate, and the like) typically used to store fluids such as liquid, or flowable materials such as powders, slurries, particulates, and the like. The materials used to fabricate the main container 12 and the concentrate container 14, are preferably resistant to the ingredients, which will be stored and/or dispensed from the container 12 or 14. the selection of a suitable material for construction of the respective containers is well within the skill of the art.

It will be further understood that the number of concentrate containers 14 is not limited to one, and that a plurality of concentrate containers 14 may be utilized in the present system such as when packaged as a plurality of concentrate containers. The plurality of the concentrate containers 14 may contain the same concentrate formulation, or a combination of different concentrate formulations, wherein each of the concentrate formulations may vary in terms of concentration levels for the same active ingredients and/or contain different active ingredients. This provides the consumer with a ready supply of concentrates from which the ready to use fluid product (e.g., spray product) can be prepared, and/or provides a selection of concentration choosing by the consumer for a particular application or need.

The main container 12 is configured to store and dispense a ready to use fluid product (e.g., spray product). The main container 12, shown in FIG. 1, comprises a vessel 16 having a neck portion 22 with external threads 23 extending therearound for regularly engaging a trigger spray mechanism 20 via an externally threaded collar 25. An opening 24 at the top end thereof, which is adaprted to receive the interanally threaded collar 25 to provide an operable spray bottle suitable for consumer dispensing of the fluid. The vessel 16 further defines an interior fluid cavity 18 in fluid communication with the opening 24 for holding a fluid to be dispensed.

The trigger-spray device 20 includes a positive displacement pump (not shown) actuated by a trigger 26, a dip tube 28 extending into the lower region of the cavity 18, and a nozzle 30. Such trigger spray devices are well known in the art. Upon actuation of the trigger 26, the spray product stored in the cavity 18 is drawn through the dip tube 28 and discharged as a spray through the nozzle 30. The nozzle 30 may be adjustable, so as to select the type of fluid discharge, typically a stream, a mist, or a spray.

The concentrate container 14 is configured to store a concentrate 40 from which the ready to use fluid product is prepared. The concentrate container 14 comprises a vessel 32 having a neck portion 34 with external threads 36 extending therearound, and an opening 38, which is sealed by a sealing means 44 at the top end thereof. The neck portion 34 of the vessel 32 is configured to have a smaller diameter than the neck portion 22 of the vessel 16, so that the neck portion 34 is insertable into, and thereby engages with, the main container via an insert or coupling element when the concentrate container is ready to discharge the concentrate into the main container.

The vessel 32 further defines an interior fluid cavity 42 in fluid communication with the sealed opening 38 for holding the concentrate 40. The sealed opening 38 is sealed by the sealing means 44, preferably hermetically such as by a membrane or a similar device securely affixed thereto. The membrane 44 may be composed of a chemically resistant material selected from a film, a foil, a composite, a laminate, or any other suitable material that can be punctured or pierced by the discharge mechanism contained within the insert or coupling element, as hereafter described.

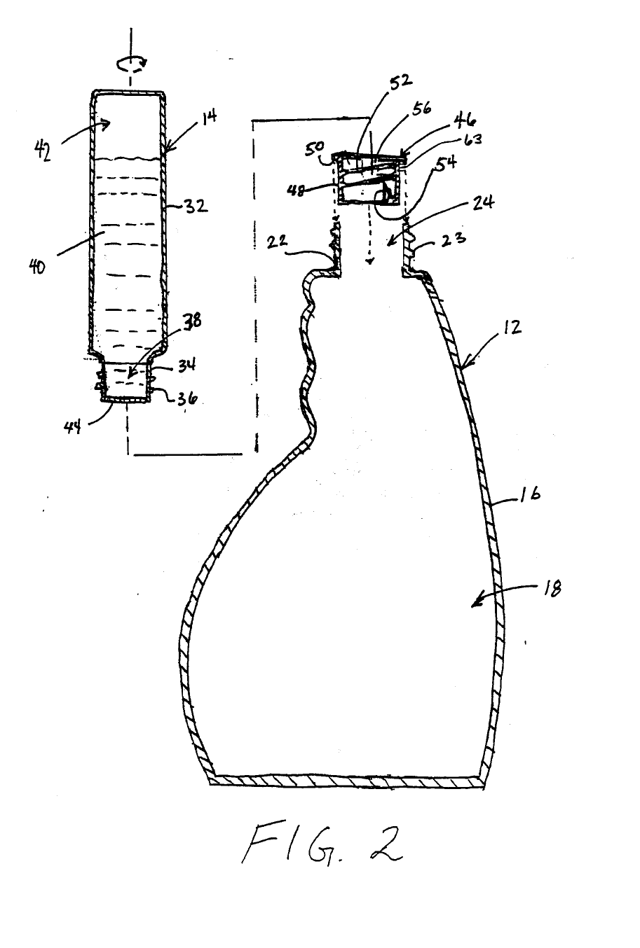

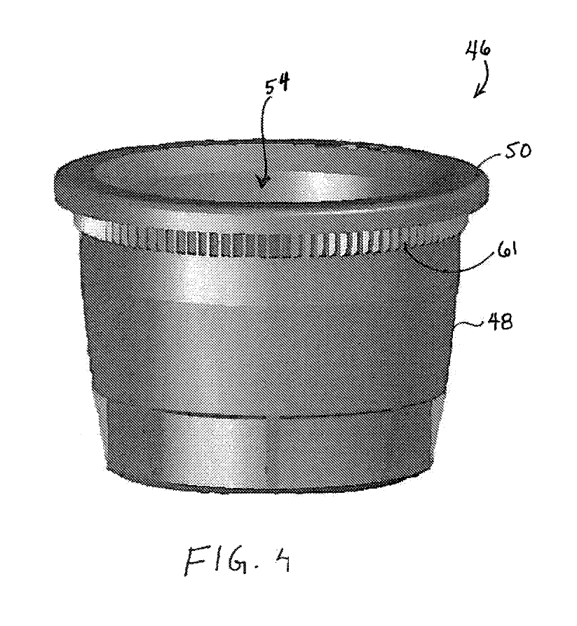

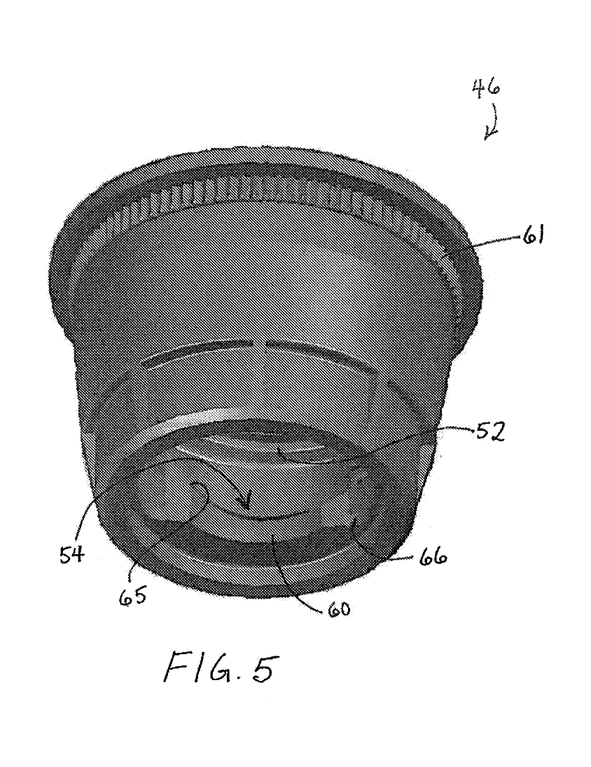

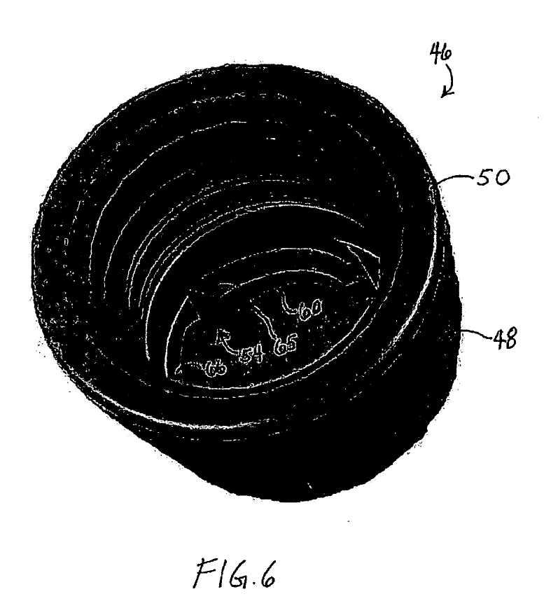

Referring to FIGS. 2 and 4-6, the main container 12 further comprises an insert in the form of a coupling element 46 positioned within the opening 24 for facilitating attachment of the concentrate container 14. The coupling element 46, which is adapted to seat within the upper region of the neck portion 22 of the main container 12, includes an annular member 48 with top and bottom ends, a flange portion 50 extending around the top end thereof, a threaded interior portion 52 defining a through hole 56, and a discharge mechanism 54 including a discharge element 60 projecting from the bottom end towards the top end of the annular member 48.

The outer portion of the annular member 48 is suitably dimensioned for a flush or press fit within the interior of the neck portion 22 of the vessel 16 and may be provided with serrations 61 (alternating grooves and projections) adapted for reverse locking engagement with corresponding serrations 63 appearing on the inner surface of the neck portion 22, shown in FIGS. 2, 4, and 5. The interlocking engagement prevents the coupling element 46 from rotating during coupling of the concentrate and the main containers. An adhesive, a fastener or other suitable means may also be used to securely affix the coupling element 46 within the neck portion 22 of the vessel 16.

The coupling element 46 is inserted bottom end-first into the opening 24 of the vessel 16. The flange portion 50 engages and abuts against the top end of the vessel opening 24 for ensuring proper placement and seating. The coupling element 46 is configured to function compatibly with the trigger-spray 20 as the through hole 56 of the coupling element 46 extends co-axially with the opening 24 of the vessel 16. The threaded interior portion 52 of the coupling element 46 is dimensioned to receive and accommodate the neck portion of the concentrate vessel 32, which engages the exterior threads 36 of the concentrate vessel 32 to form a secure fluid couple between the main container 12 and the concentrate container 14.

The discharge mechanism 54 is designed to exert pressure on the sealing means 44 (e.g. membrane) by the discharge element 60 so as to provide a controlled puncture of the membrane on contact. When the initial puncture is made and the concentrate container 14 is further rotated within the coupling element 46, a releasing surface 65 of the discharge mechanism forces the membrane to separate sufficiently from the opening of the concentrate container to cause the concentrate to be released from the concentrate container. However, the portion of the membrane is retainer at the opening, so that the punctured membrane is not released into either container. This is accomplished by limiting rotation of the releasing surface 65 so that it does not make a complete rotation within the neck portion of the main container. Less than a complete revolution ensures that a small portion of the sealing means will remain attached to the neck portion 34. The sealing means does not enter either of the containers 12 or 14 while releasing the concentrate into the main container.

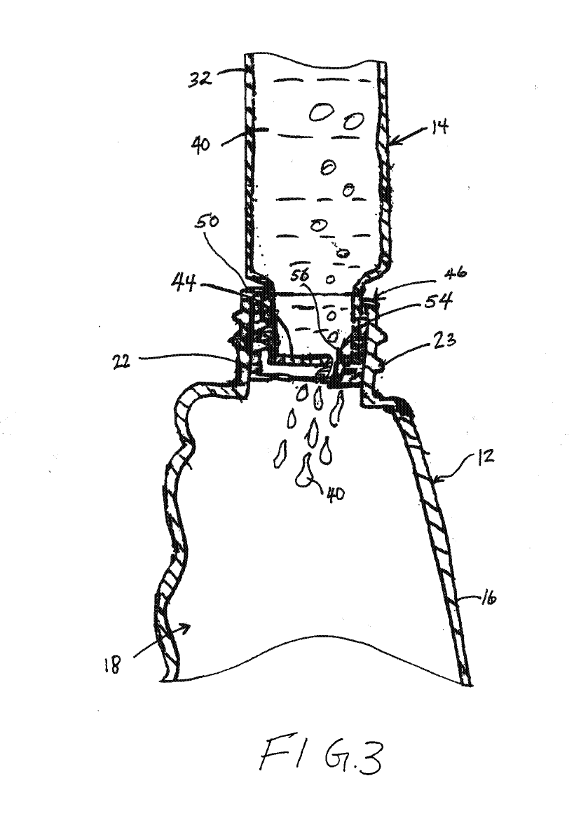

Referring to FIG. 3, the neck portion 34 of the concentrate container 14 is threadedly coupled to the coupling element 46 of the main container 12. As the concentrate container 14 is screwed into the coupling element 46, the sealed opening 38 moves downward toward the discharge mechanism 54, and particularly the discharge element 60. The threaded engagement between the concentrate container 14 and the main container 12 ensures that the concentrate 40 does not spill or leak during the refill process as described above. Furthermore, the concentrate container 14 remains secured to the main container 12 in the event the main container 12 is inadvertently tipped or knocked on its side.

The discharge element 60, in the form of a tooth-shaped surface, is adapted to pierce or penetrate the membrane 44 as the neck portion 34 of the concentrate container 14 becomes fully seated within the coupling element 46. The turning motion of the concentrate container 14 causes the discharge element 60 to pierce the membrane 44 and travel along the edge portion of the membrane 44 forming a circularly shaped aperture. The piercing action of the discharge mechanism 56 releases the concentrate 44 from the concentrate container 14 into the cavity 18 of the main container 12. The release of the concentrate 40 occurs only when the concentrate container 14 is fully seated in the coupling element 46. This feature greatly minimizes spillage or contact with the concentrate 40.

In a further aspect of the invention, the coupling element 46 is provided with a smooth area between the interior threaded portion 52 and the base 66 of the discharge 60. This smooth area lies in close proximity to, or slightly engages, a corresponding surface of the neck portion 34 of the concentrate container. As a Consequence, the airspace between the two surfaces is limited, thereby preventing accidental discharge of the concentrate through a bubble-up effect created by the buildup and release of air pressure when the membrane is punctured.

When the concentrate 40 is fully discharged into the main container 12, the concentrate container 14 is loosened from the coupling element 46 and removed. The concentrate 40 is reconstituted by adding a sufficient quantity of diluent such as water to the cavity 18 of the main container 12. The quantity of water added dilutes the active ingredient(s) in the concentrate 40 to a desired dilute concentration range to produce a ready to use fluid product. The trigger-spray device 20 is then threadedly engaged to the neck portion 22 of the vessel 16 with the dip tube 28 extending into the reconstituted ready to use fluid product. When the ready to use fluid product has been fully dispensed, the refill process can be repeated using a fresh concentrate container filled with a concentrate to replenish the main container 12.

The present invention provides advantages over conventional methods of forming fluid products from concentrates. First, the concentrate is contained within a concentrate container that is always utilized exterior to the main container. Accordingly, the concentrate container may be manufactured separately from the main container and sold in packages containing multiple concentrate containers. In addition, the separately packaged concentrate containers may be utilized with a standard spray bottle, thus reducing the cost and waste associated with manufacturing multiple main containers.

Secondly, the coupling element for use in the neck portion of the main container allows easy transfer of the concentrate from the concentrate container without spillage, especially spillage caused by the build up and release of the air in the neck portion of the main container and the outer surface of the coupling element prevent the coupling element from moving within the respective containers.

### EXAMPLES

### Example 1

### Glass Cleaner Concentrate Formulation

A glass cleaner formulation is prepared as a concentrate through mixing and blending of the components in the amounts listed in Table 1.

TABLE 1

| | Amount |
|---|---|
| Component | (% v/v) |
| Deionized water | 16.0 |
| 2-Amino-2-methyl-1-propanol | 10.0 |
| Ethylenediamine Tetraacetic Acid | 2.0 |
| Sodium lauryl sulfate | 2.0 |
| Dipropylene glycol monomethyl ether | 5.0 |
| Propylene glycol monobutyl ether | 5.0 |
| Isopropyl Alcohol | 58.515 |
| Fragrance | 1.35 |
| Dye | 0.135 |

The glass cleaner formulation concentrate can be subsequently re-constituted in the main container by the consumer to yield a ready to use fluid product. This is achieved by adding water as a diluent to obtain a final water content of from about 95% to 99% by volume based on the total volume.

### Example 2

### Degreaser Concentrate Formulation

A degreaser formulation is prepared as a concentrate through mixing and blending of the components in the amounts listed in Table 2.

TABLE 2

| | Amount |
|---|---|
| Component | (% v/v) |
| Deionized water | 22.0 |
| Nonionic surfactant blend | 50.0 |
| 2-Amino-2-methyl-1-propanol | 10.0 |
| Potassium hydroxide | 7.0 |
| Ethylenediamine Tetraacetic Acid | 4.0 |
| Sodium octyl sulfate | 5.0 |
| Fragrance | 1.89 |
| Dye | 0.11 |

The degreaser formulation concentrate can be subsequently re-constituted in the main container by the consumer to yield a ready to use fluid product. This is achieved by adding water as a diluent to obtain a final water content of from about 95%-99% by volume based on the total volume.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A container system, comprising:
(a) a concentrate component comprising:
at least one concentrate container, each including a vessel defining a cavity, and a neck portion extending from the vessel;
an opening extending through the neck portion, and in fluid communication with the cavity;
a concentrate stored in the cavity; and
sealing means operatively associated with said opening for sealing the concentrate within the cavity; and
(b) a main component comprising:
a main container including an opening and a cavity in fluid communication with the opening;
coupling means located at the opening of the main container for receiving and fluidly coupling with the neck portion of the concentrate container; and
a discharge mechanism operatively associated with the coupling means, said discharge mechanism being adapted for operatively engaging the sealing means to initiate the release of the concentrate from the concentrate container into the cavity of the main container.

2. The container system of claim 1, wherein the sealing means comprises a membrane.

3. The container system of claim 2, wherein the membrane is selected from the group consisting of a film, a foil, a laminate, a composite, and combinations thereof.

4. The container system of claim 1, wherein the sealing means engaging means comprises a releasing surface for engaging the sealing means, and separating a portion of the sealing means from the opening of the concentrate container.

5. The container system of claim 2, wherein:
the coupling means comprises a threaded portion extending along an interior segment of the opening of the main container; and
the neck portion of the concentrate container comprising the threaded portion configured for engagement to the threaded portion of the coupling means.

6. The container system of claim 5, wherein the coupling means has an exterior surface having a plurality of spaced apart serrations for engaging corresponding serrations on an interior surface of the neck portion of the main container to ensure secure seating of the coupling means within the neck portion of the main containers.

7. The container system of claim 5, wherein the discharge mechanism comprises a discharge element adapted for piercing said membrane of the concentrate container, said discharge element located in the opening of the main container and proximate to said threaded portion of the main container.

8. The container of claim 2, wherein said coupling means comprises:
an annular member configured for a flush fit within the opening of the main container; and
retaining means extending along the periphery of the annular member for securely positioning the annular member proximate the opening of the main container.

9. The container system of claim 8, wherein:
the annular member comprises a threaded portion extending along the inner portion thereof; and
the neck portion of the concentrate container comprises a threaded portion configured for engagement to the threaded portion of the annular member.

10. The container system of claim 8, wherein the discharge mechanism is located within the inner portion of the annular member.

11. The container system of claim 10, wherein the discharge mechanism comprises a discharge element adapted for puncturing said membrane of the concentrate container, said discharge element located in the opening of the main container and proximate to said threaded portion of the annular member.

12. The container system of claim 1, wherein the concentrate is in the form selected from the group consisting of a liquid, flowable material, and combinations thereof.

13. The container system of claim 1, further comprising a trigger spray adapted for attachment to the opening of the main container.

14. The container system of claim 1, comprising a plurality of concentrate containers.

15. The container system of claim 14, wherein each concentrate container contains the same concentrate.

16. The container system of claim 14, wherein the concentrate containers contain different concentrates.

17. A container system, comprising:
at least one concentrate container, each including an opening and a cavity in fluid communication with the opening thereof, said cavity of the concentrate container being adapted to retain a quantity of a concentrate;
a sealing means operatively associated with the opening of the concentrate container for sealing the concentrate within the cavity;
a main container including an opening, and a cavity in fluid communication with the opening thereof, said opening of the main container being adapted to receive and fluidly couple with the opening of the concentrate container; and
a discharge mechanism located proximate to the opening of the main container, said discharge mechanism being adapted for operative engagement with the sealing means of the concentrate container to initiate the release of the concentrate from the cavity of the concentrate container into the cavity of the main container.

18. The container system of claim 17, wherein the sealing means comprises a membrane.

19. The container system of claim 17, further comprising a trigger spray adapted for attachment to the opening of the main container.

20. The container system of claim 17, comprising a plurality of concentrate containers.

21. The container system of claim 20, wherein each concentrate container contains the same concentrate.

22. The container system of claim 20, wherein the concentrate containers contain different concentrates.
